(19) United States
(12) Patent Application Publication
(10) Pub. No.: US 2011/0310758 A1
(43) Pub. Date: Dec. 22, 2011

(54) Method of Resource Assignment for Radio Communication System and Base Station Apparatus

(75) Inventors: Satoshi Tamaki, Yokohama (JP); Rintaro Katayama, Fujisawa (JP); Tomonori Yamamoto, Fujisawa (JP); Hirotake Ishii, Yokohama (JP)

(73) Assignee: Hitachi, Ltd., Tokyo (JP)

(21) Appl. No.: 13/159,924

(22) Filed: Jun. 14, 2011

(30) Foreign Application Priority Data
Jun. 18, 2010 (JP) 2010-138883

(51) Int. Cl. H04W 72/04; H04W 24/04

(52) U.S. Cl. 370/252; 370/329

(57) ABSTRACT

A method for assigning resources of a radio communication system that is aimed at relaxing interference between cells and that is applicable even in the case where femtocell base stations are installed within a macrocell base station area, and a radio base station apparatus. A transmit power limitation that limits an allocatable resource for each subband consisting of one or plural sub-carriers is decided, resource assignment is preformed on a mobile terminal on a subband-by-subband basis by a scheduler so that the transmit power limitation may be satisfied, and the transmit power limitation is altered based on an estimation result of an interference quantity from surrounding cells.

### CLAIM OF PRIORITY

The present application claims priority from Japanese patent application JP 2010-138883 filed on Jun. 18, 2010, the content of which is hereby incorporated by reference into this application.

### FIELD OF THE INVENTION

The present invention relates to a radio communication system and more specifically to an apparatus and a method for assigning a radio resource.

### BACKGROUND OF THE INVENTION

With increasing frequency band of radio communication, a multi-carrier communication method for performing communication by dividing transmission information into multiple frequency bands (hereinafter each referred to as “sub-carriers”) is being used. Among the multi-carrier communication methods, an OFDM (Orthogonal Frequency Division Multiplexing) system is adopted in a wide variety of systems because it can improve tolerance against a delayed wave by narrowing a bandwidth per sub-carrier and at the same time can realize a high frequency utilization efficiency by negating a guard band among the sub-carriers through a use of orthogonality of signals. Moreover, an OFDMA (Orthogonal Frequency Division Multiple Access) system that performs multiple access by dividing a radio resource of the OFDM system into units each having one or plural sub-carries and a fixed duration (hereinafter referred to as a “resource block”) has been adopted in systems called WiMAX (Worldwide Interoperability of Microwave Access) and LTE (Long Term Evolution).

For example, 3rd Generation Partnership Project: TSG RAN; E-UTRA; Physical Channels and Modulation (Release 9), 3GPP TS 36.211 V9.0.0, 2009/12 describes a radio resource division and a modulation method in the LTE. For downlink data communication from a base station to a mobile terminal, an OFDMA system of directly assigning a modulated signal of each user to time and frequency resources is described. On the other hand, for uplink data communication from the mobile terminal to the base station, an SC-FDMA (Single Carrier-Frequency Division Multiple Access) system of assigning the modulated signal after being temporarily converted by DFT (Discrete Fourier Transform) to the time and frequency resources is described.

These radio communication systems use an ICIC (Inter-cell interference Coordination) technology of providing a limitation on the resource used for each cell in order to reduce interference between cells. For example, Japanese Unexamined Patent Application Publication (Translation of PCT Application) No. 2008-530918 discloses a technology of using a different frequency according to a position of the mobile terminal located within the cell in order to reduce the inter-cell interference.

Moreover, in the radio communication system, multiple installation of base stations with high transmit power (hereinafter each referred to as a “macrocell base station”) and whose cover area per base station extends to, for example, hundreds meters to a few kilometers enables the mobile terminal to perform radio communication in a wide area range. However, since radio waves used for radio communications are blocked or attenuated, for example, by buildings etc., there emerge places where the radio wave from the macrocell base station becomes weak, for example, inside a house etc. Moreover, the wider the cover area of the macrocell base station, the more the number of mobiles stations in the area increases, the radio resource available for each mobile terminal is decreased.

For this reason, there is a case where the base station whose transmit power is low and whose cover area per base station is narrow (hereinafter referred to as a “femtocell base station”) is installed. The installation of the femtocell base station enables the mobile terminal to perform stable communication even in a place where the radio wave from the macrocell base station becomes weaker, and enables the radio resource that each mobile terminal can use to be increased by decreasing the number of mobile terminals per base station.

### SUMMARY OF THE INVENTION

For example, Japanese Unexamined Patent Application Publication (Translation of PCT Application) No. 2008-530918 proposes a technology that classifies users into users in an internal area of a cell and users in an external area thereof, and makes them use mutually different resources, respectively. The technology of Japanese Unexamined Patent Application Publication (Translation of PCT Application) No. 2008-530918 is based on a premise that multiple macrocell base stations constitute radio communication areas and a cell edge of a certain cell adjoins a cell edge of an other cell. For this reason, for example, in a case where a femtocell base station is installed inside a macrocell base station area and an area in the macrocell adjoining the cell edge of the femtocell does not necessarily a cell edge for the macrocell base station, or a like case, there occurs a problem that an effect of interference reduction between cells that is intended to be the object is limited.

The present invention provides a method for assigning a resource of a radio communication system that is aimed at reducing interference between cells of the macrocell base station and the femtocell base station, and a radio base station apparatus.

In order to solve at least one of the above-mentioned problems, in a multi-carrier radio communication system having multiple sub-carriers that is one aspect of the present invention, the base station apparatus for performing radio communication with multiple mobile terminal apparatuses has: a cell environment determination processing part for estimating an interference quantity from surrounding cells; a scheduler for performing resource assignment to the mobile terminals on a basis of subband-by-subband consisting of one or plural sub-carriers; and an inter-cell interference coordination processing part for deciding a transmit power limitation that restricts an allocatable resource for the each subband; wherein the transmit power limitation in the inter-cell interference coordination processing part is altered based on an interference quantity estimation result by the cell environment determination processing part.

According to one aspect of the present invention, the interference between cells is reduced.

### BRIEF DESCRIPTION OF THE DRAWINGS

FIG. 1 is a diagram showing a configuration example of a radio communication system;

FIG. 2 is a diagram showing one example of a configuration of a radio base station apparatus;

FIG. 3 is a diagram showing one example of a sequence of a radio access measurement function using a measurement function of a mobile terminal;

FIG. 4 is a diagram showing one example of resource assignment by a radio resource assignment function in an OFDMA system;

FIG. 5 is a diagram showing one example of division of a band for inter-cell interference coordination;

FIG. 6 is a diagram showing one example of a configuration of functional blocks of an inter-cell interference coordination function;

FIG. 7 is a diagram showing one example of an outline of downlink mobile terminal class determination;

FIG. 8 is a diagram showing one example of a possibility of assignment information table for each subband;

FIG. 9 is a diagram showing one example of an outline of uplink mobile terminal class determination;

FIG. 10 is a diagram showing one example of a flow of a processing of cell environment determination;

FIG. 11 is a diagram showing another example of a flow of the processing of the cell environment determination;

FIG. 12 is a diagram showing another example of a flow of the processing of the cell environment determination;

FIG. 13 is a diagram showing another example of a flow of the processing of the cell environment determination;

FIG. 14 is a diagram showing another example of a flow of the processing of the cell environment determination; and

FIG. 15 is a diagram showing one example of a configuration of the base station apparatus constructed with a DSP and a CPU as main constituents.

### DETAILED DESCRIPTION OF THE PREFERRED EMBODIMENTS

Hereafter, embodiments of the present invention will be described using drawings.

Incidentally, below, a pilot signal refers to a signal having a fixed or semi-fixed pattern that is used as a reference signal of amplitude and phase in demodulating a received signal or as a reference signal for estimating a received power or propagation path information, and is also called a reference signal. Moreover, the pilot signal used as the reference signal in the demodulating and the pilot signal used as the reference signal for estimating the received power or the propagation path information may be the same or may be different. Furthermore, the pilot signal may be used in common in multiple mobile terminals within the cell, and may be individually used for each mobile terminal.

Moreover, in the following example, although a sequence and a flow of processings may be explained in a specific order, an order of a processing may be changed and the processings may be performed in parallel except a case where there is a dependence on the order, such as a case of using a result of a certain processing in the following processing. Moreover, in the following example, although in order to explain a resource assignment method of this embodiment, a base station that is focused is designated as a femtocell base station and a base station existing around the femtocell base station is designated as a macrocell base station, the resource assignment method of this embodiment may be applied, for example, to macrocell base stations. Moreover, in the following, when there is no necessity of differentiating the femtocell base station to which the resource assignment method of this embodiment is applied and the macrocell base station around it, it is called simply the base station.

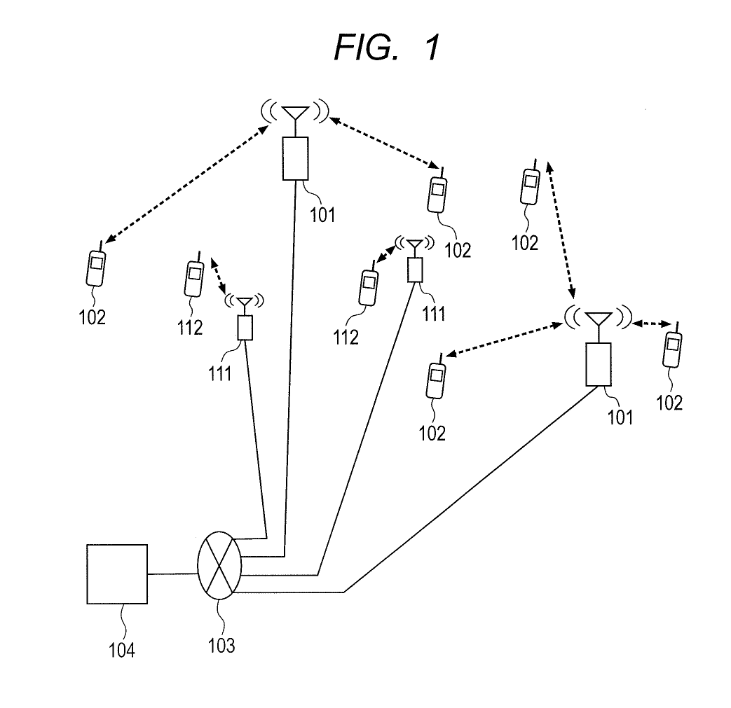

FIG. 1 is a diagram showing a configuration of a radio communication system in this embodiment. The radio communication system of this configuration example has multiple macrocell base stations 101, multiple femtocell base stations 111, multiple mobile terminals 102 and 112, a network 103 connected with the base stations, and a core network 104 connected with the base stations through a network 103. Below, the signal and communication that are forwarded to the mobile terminals 102 or 112 from the macrocell base station 101 or the femtocell base station 111 are referred to as a downlink signal and downlink communication, respectively. Conversely, the signal and communication that are forwarded to the macrocell base station 101 or the femtocell base station 111 from the mobile terminals 102 or 112 are referred to as an uplink signal and uplink communication, respectively.

The macrocell base station 101 is connected with the core network 104 through the network 103. The macrocell base station 101 transmits the downlink signal to the mobile terminal 102, and receives the uplink signal transmitted by the mobile terminal 102. The femtocell base station 111 is connected with the core network 104 through the network 103 like the macrocell base station 101, transmits the downlink signal to the mobile terminal 112, and receives the uplink signal transmitted by the mobile terminal 112.

The network 103 to which the macrocell base station 101 is connected and the network 103 to which the femtocell base station 111 is connected may be the same network, or may be another networks connected with each other through a gateway. The core network 104 has a mobility management function and a gateway function with other networks.

Whether the mobile terminal 102 or 112 communicates with the macrocell base station 101 or communicates with the femtocell base station ill is decided based on a reception quality and propagation loss of the downlink signal or uplink signal, and when a propagation environment changes due to travelling of the mobile terminal etc., a handover processing in which the base station performing the communication through the core network 104 is changed is performed. In FIG. 1, a range in which the femtocell base station 111 communicates with the mobile terminal is narrower than a range in which the macrocell base station 101 communicates with the mobile terminal. Moreover, regardless of the macrocell base station and the femtocell base station, the ranges in which the base stations communicate may be in an inclusion relation among multiple base stations, and parts of the ranges may overlap with each other.

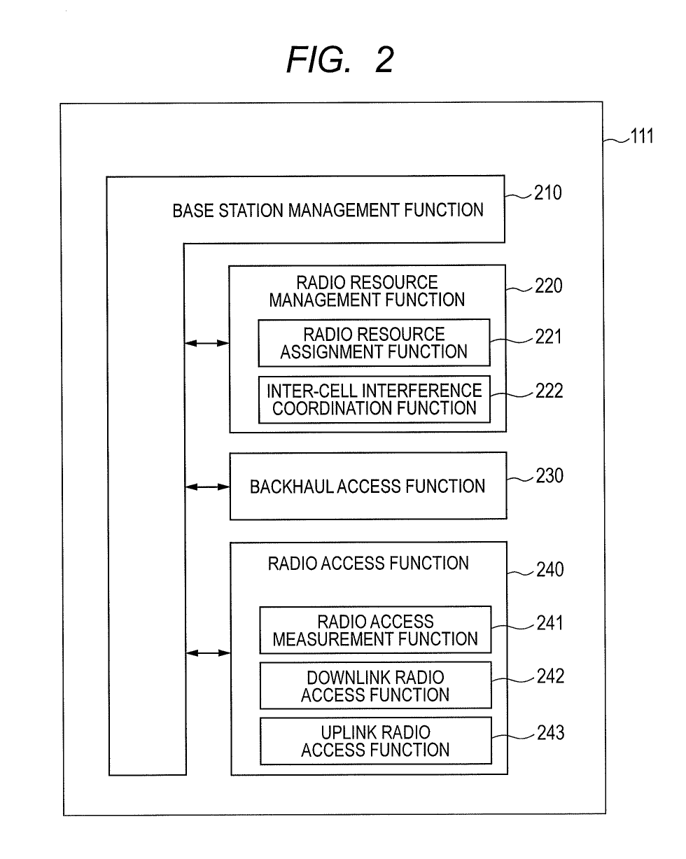

FIG. 2 is a diagram showing one example of a configuration of a radio base station apparatus in this embodiment. The radio base station includes a base station management function 210, a radio resource management function 220, a backhaul access function 230, and a radio access function 240.

The base station management function 210 is a function for managing and controlling the whole base station. The base station management function 210 performs setting and management of parameters at the time of beginning of base station operation, at the time of base station normal operation, etc. and an operation control of each function of the radio resource management function 220, the backhaul access function 230, and the radio access function 240.

In addition to a radio resource assignment function 221 and an inter-cell interference coordination function 222, the radio resource management function 220 performs a control of a radio bearer, a connection control of the mobile terminal, and a control of travelling of the mobile terminal between base stations. The radio resource assignment function 221 is a function also called as a scheduler, and assigns individual communication between the base station and the mobile terminal and communication of notification information from the base station to a radio resource that includes at least one of a frequency resource and a time resource. The inter-cell interference coordination function 222 acts as an interface of information notification among cells that is intended to reduce the interference and decides and notifies a limitation against resource assignment the radio resource assignment function 221. More specifically, the inter-cell interference coordination function 222 divides a system band into one or plural subbands, and provides the limitation of the resource assignment on radio resource assignment using measurement information and information notified from surrounding cells for each divided subband.

The backhaul access function 230 is a communication function between the base station and the network, and performs communication of control information and communication data between the core network 104 and the base station and between the base stations.

The radio access function 240 is a communication function between the base station and the mobile terminal through a wireless channel, and includes a radio access measurement function 241, a downlink radio access function 242, and an uplink radio access function 243.

The radio access measurement function 241 measures the reception quality of a signal from each mobile terminal in a local base station area and an interference power resulting from a transmitting signal of the mobile terminal outside the local base station area. Moreover, it may measure the interference power resulting from a transmitting signal of other base stations. Furthermore, in order to use a measurement result of the mobile terminal, the radio access measurement function 241 may notify a request for measurement report to the mobile terminal, and may be notified of the measurement result from the mobile terminal. Incidentally, the reception quality includes, for example, values of a received signal power and a ratio of the received signal power versus interference and noise power. Moreover, the measurement of the power is done independently for a fixed bandwidth or collectively for all the bandwidths. The radio access measurement function 241 notifies these measurement results to other functions directly or notifies after accumulating and statistically processing.

The downlink radio access function 242 is a radio communications transmission function from the base station to the mobile terminal. It transmits the notification information from a core network, data to each and individual mobile terminal, the control information from the base station for controlling communication in a radio link, information on assignment of the uplink and downlink radio resource, etc. individually for each mobile terminal or as the broadcast information after converting them into a format suitable for communication in the radio link.

The uplink radio access function 243 is a radio communication reception function from the mobile terminal to the base station. It receives an individual data signal from each mobile terminal or the control information. Moreover, the downlink radio access function 242 and the uplink radio access function 243 work together with close connection to perform controls such as a retransmission control or a transmit power control.

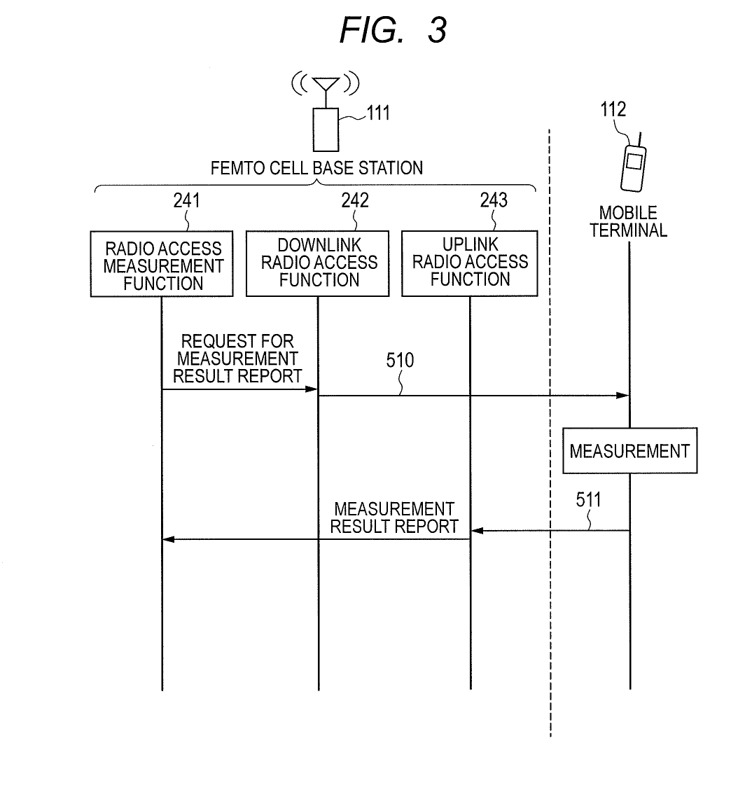

FIG. 3 is a diagram showing one example of a sequence of the radio access measurement function 241 using a measurement function of the mobile terminal.

When using the measurement function of the mobile terminal, the radio access measurement function 241 notifies a measurement result report requesting message 510 to the mobile terminal through the downlink radio access function 242. The mobile terminal 112 performs a measurement processing according to the measurement result report requesting message 510, and reports a result as a measurement result report message 511. The base station 111 receives the measurement result report message 511 from the mobile terminal through the uplink radio access function 243 at the radio measurement function 241. Incidentally, one measurement result report message 511 may correspond to one measurement result report requesting message 510. Alternatively, the measurement result report requesting message 510 may include a specification of the number of reports or a report cycle, and the mobile terminal may report multiple measurement result report messages 511 to the base station according to the specification.

What are to be measured in the measurement processing of the mobile terminal are the received power at the mobile terminal of the pilot signal from the measurement result requesting base station, the received power of the pilot signal from a base station different from the measurement result report requesting base station. Moreover, the mobile terminal may perform the measurement processing upon reception of the measurement result report requesting message 510, or may report the result having been measured separately upon reception of the measurement result report requesting message 510.

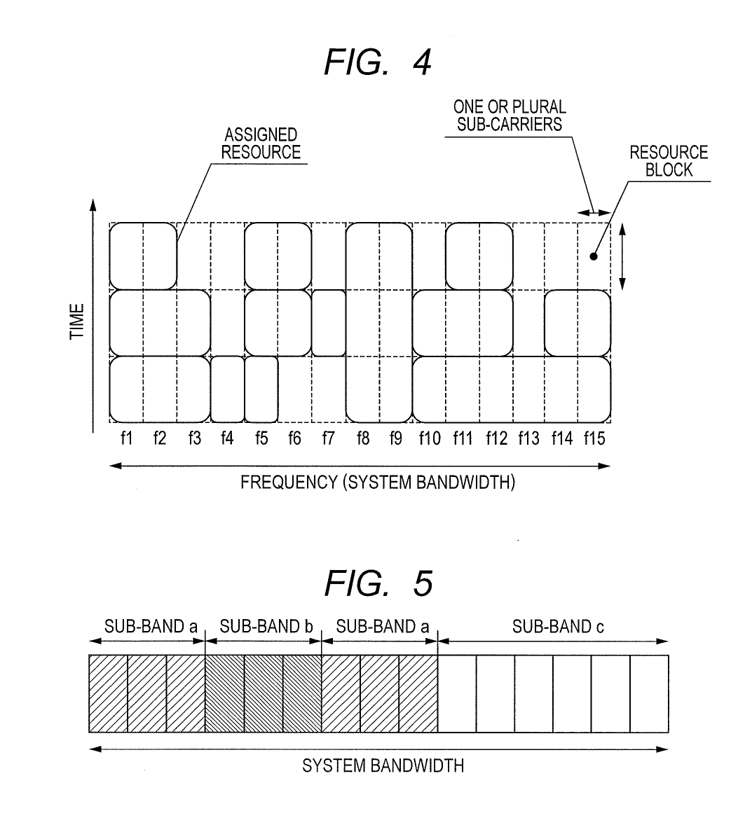

FIG. 4 is a diagram showing one example of the resource assignment by the radio resource assignment function 221 in an OFDMA system. In the radio resource assignment, resources are assigned in one or plural resource blocks that is an assignment unit surrounded by dashed lines. The resource block is a range of time and frequency such that the resource is delimited by a unit time in a time axis direction and by one or plural sub-carriers in a frequency direction. For example, in the case of LTE, the unit time of the resource block is 1 ms, corresponding to six or seven OFDM symbols, and the number of sub-carriers per resource block is 12 in the frequency direction. The radio resource assignment when performing uplink or downlink communication is done by assigning the resources collectively by putting together one or plural resource blocks as designated as assigned resources in the figure.

FIG. 5 is a diagram showing one example of division of the band for inter-cell interference coordination. In order to perform the inter-cell interference coordination, the system band is divided into one or plural subbands having a bandwidth equivalent to one or plural resource blocks. FIG. 4 is an example where the system bandwidth has a bandwidth equivalent to 15 resource blocks, in which a bandwidth equivalent to six resource blocks are assigned as a subband a, a bandwidth equivalent to three resource blocks are assigned as a subband b, and a bandwidth equivalent to six resource blocks are assigned as a subband c. A single subband may correspond to continuous resource blocks like the example of the subband b and the subband c, and may correspond to a group of the resource blocks that are not continuous like the example of the subband a.

Incidentally, in an example of FIG. 5, the system band is divided into three subbands. However, the number of division does not need to be limited to three, the system band may be divided into two, four, or more subbands, or there may exist abase station that does not divide the system band and handles it as a single subband. Moreover, a bandwidth per sub-block does not necessarily need to be a bandwidth equivalent to the resource blocks, and there may exist a subband equivalent to a single resource block width.

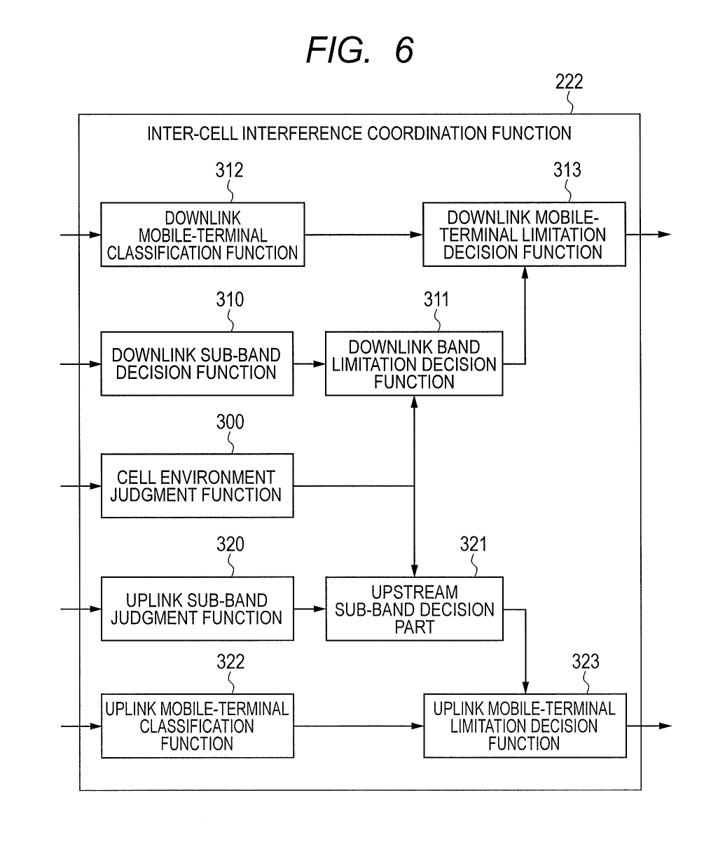

FIG. 6 is a diagram showing one example of a block configuration of the inter-cell interference coordination function 222. The inter-cell interference coordination function 222 consists of a cell environment judgment function 300, a downlink subband judgment function 310, a downlink band limitation decision function 311, a downlink mobile terminal classification function 312, a downlink mobile terminal limitation decision function 313, an uplink subband determination part 320, an uplink band limitation decision function 321, an uplink mobile terminal classification function 322, and an uplink mobile terminal limitation decision function 323.

The cell environment judgment function 300 judges whether a cell environment is a collision type or avoidance type based on a measurement result in the radio access measurement function 241, etc. and notifies the determination result to the downlink band limitation decision function 311 and the uplink band limitation decision function 321. For example, the cell environment that is judged corresponds to a positional relation of the femtocell base station and the macrocell base station and a statistic of the received powers of the signals transmitted from other base stations in the mobile terminal belonging to a communication range of the base station. It is judged to the collision type, if the cell environment corresponds to an environment where the femtocell base station and the macrocell base station are close proximity to each other and an environment where the received power statistic is lower than a predetermined value. It is judged to the avoidance type, the cell environment corresponds to an environment where the femtocell base station and the macrocell base station are far in distance, such as a case where the femtocell base station is located at a cell edge of the macrocell base station, and an environment where the received power statistic is higher than the predetermined value.

The downlink subband judgment function 310 predicts interference for each downlink subband, judges whether the interference is large or small, and notifies it to the downlink band limitation decision function 311. Regarding an interference prediction method, prediction is done by the following steps: the received power of the pilot signal from an other base station is measured in the radio access measurement function 241; and as a result, it is judged that a subband whose received power is large has large interference, and a subband whose received power is small has small interference. Alternatively, as another method, it can be done that information notification that a transmit power is large or small for each subband through a network of one or plural other base stations is received, a subband such that there exist base stations notifying a large transmit power more than or equal to a threshold is judged to have large interference and other subbands are judged to have small interference. Alternatively, it is possible to judge subbands have larger interference when the number of base stations which notifying a large transmit power are large. Further, alternatively, a notification of large or small interference for each subband may be received directly from the network through the backhaul access function 230.

The downlink band limitation decision function 311 decides a limitation for each subband based on the determination result of the cell environment and the interference largeness/smallness determination result for each subband, and notifies the limitation for the each subband to the downlink mobile terminal limitation decision function 313. When the notification from the cell environment judgment function 300 is the avoidance type, the downlink band limitation decision function 311 associates a strinter limitation with the subband that is judged to have larger interference, and associates a looser limitation with the subband that is judged to have smaller interference. Then, the downlink band limitation decision function 311 notifies the limitation of the downlink band to the downlink mobile terminal limitation decision function 313 for each subband. When the notification from the cell environment judgment function 300 is the collision type, the downlink band limitation decision function 311 associates a looser limitation with the subband that is judged to have larger interference, associates a stricter limitation with the subband that is judged to have smaller interference, and notifies the associated limitation to the downlink mobile terminal limitation decision function 313.

Here, stricter limitation means that the condition about the mobile terminal to which the resource is allocatable is strict. The, subband that is associated with a stricter limitation can be assigned only to the mobile terminal that requires a lower power requirement for communication, and the mobile terminal that requires a higher power requirement for communication cannot be assigned a resource of the subband whose limitation is stricter. Incidentally, the subband whose limitation is the strictest means a subband that cannot be assigned to any mobile terminals. That is, to the limitation that is associated with the subband, an upper limit of the transmit power for communication of the mobile terminal to which the resource is allocatable is provided. Regarding the limitation where limitation A is stricter than limitation B, the subband with which the limitation A is associated can be assigned only to a mobile terminal whose requirement value of the transmit power considered necessary for communication is low, compared with the band with which the limitation B is associated.

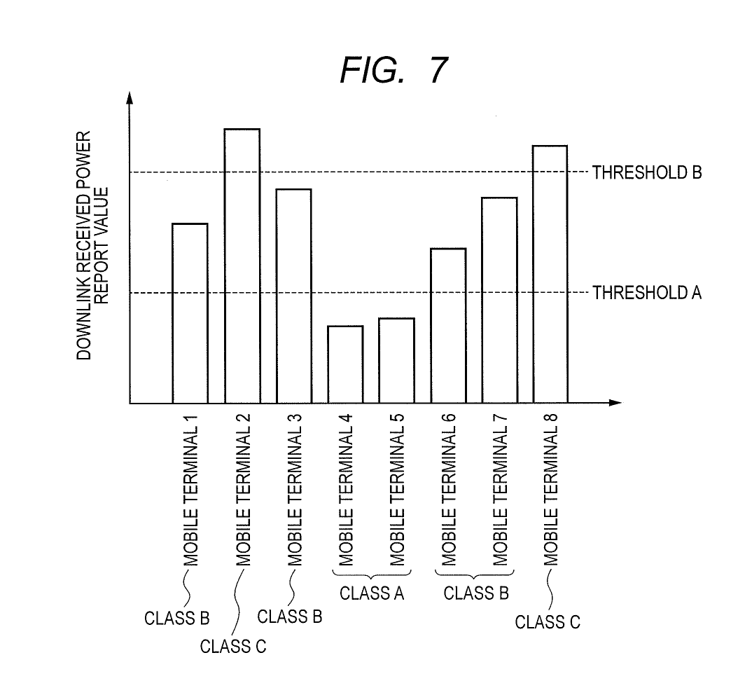

A downlink mobile terminal classification function 312 estimates the power requirement to perform the communication for each mobile terminal, decides a larger downlink mobile terminal class as the necessary power is larger, and notifies the judged downlink mobile terminal class to the downlink mobile terminal limitation decision function 313. The downlink mobile terminal classification function 312 compares a received power report value of the pilot signal obtained upon request for a measurement result report transmitted from the radio access measurement function 241 to the each mobile terminal with a threshold, and judges to which class the mobile terminal belongs. Here, downlink mobile terminal class determination will be explained using FIG. 7.

FIG. 7 is a diagram showing one example of an outline of the downlink mobile terminal class determination in the downlink mobile terminal classification function 312. The downlink mobile terminal classification function 312 compares the received power report value of the pilot signal obtained by notifying a request for measurement result report to each mobile terminal with a threshold in the radio access measurement function 241, and classifies the mobile terminals as follows: mobile terminals each having reported the received power lower than a threshold A are of a class A; mobile terminals each having reported the received power lower than a threshold B and not lower than the threshold A are of a class B; and mobile terminals other than those are of a class C. In the example of FIG. 7, since the highest transmit power is required to perform communication to the mobile terminals belonging to the class A, the class A is the highest class, and the class B and the class C are lower classes in this order.

Moreover, although the example of FIG. 7 shows an example in which eight mobile terminals are classified into three classes according to the received power, the number of mobile terminals and the number of classes for classification are not limited to these values. Moreover, regarding the downlink received power reported from each mobile terminal, the report value may be used directly or may be used after the values are averaged over a fixed time. Moreover, the value used as a criterion may be any value other than the downlink received power provided that it is a value having a correlation to communication quality and, for example, a signal-to-interference power ratio etc. may be used for it.

Moreover, the thresholds used for the classification may be varied according to a result of the classification. For example, by increasing the threshold A in the case where the number of mobile terminals belonging to the class A as the result of the classification is smaller than an assumption, and conversely by decreasing the threshold A in the case where the number of mobile terminals belonging to the class A is larger than or equal to the assumption, it is possible to restrict the number of mobile terminals for each class in an assumed range. Alternatively, by decreasing thresholds in the case where the mobile terminals are less in number compared to the surrounding cells, and by increasing thresholds in the case where the mobile terminals are many in number compared to the surrounding cells, it is also possible to achieve load distribution among cells. The above is an explanation of FIG. 7.

Returning to FIG. 6, the downlink mobile terminal limitation decision function 313 judges possibility of assignment or assignment priority for each subband of each mobile terminal and generates the determination result based on the limitation for each subband notified from the downlink band limitation decision function 311 and the class for each mobile terminal notified from the downlink mobile terminal classification function 312. The downlink mobile terminal limitation decision function 313 notifies the determination result including the possibility of assignment and the assignment priority for each subband to the radio resource assignment function 221. For example, the downlink mobile terminal limitation decision function 313 judges that for the subband whose notified limitation is strict, the low class mobile terminal can be assigned, and for the subband whose limitation is loose, the high class mobile terminal can be assigned.

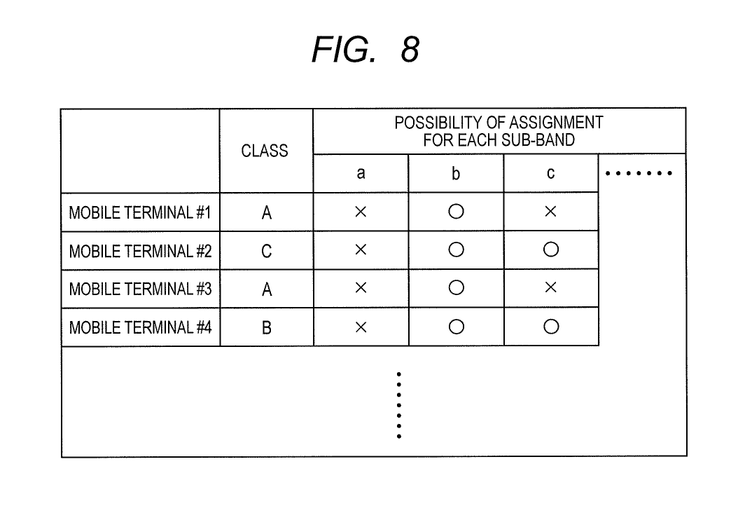

FIG. 8 is a diagram showing one example of a possibility of assignment information table for each subband that the downlink mobile terminal limitation decision function 313 notifies to the radio resource assignment function 221 as the determination result. FIG. 8 is an example of a case where the subband a is not allocatable to any mobile terminals because the limitation of the subband a is the strictest, the subband b is allocatable to all the mobile terminals because the limitation of the subband b is the loosest, and the subband c is allocatable only to the mobile terminals of the class B and the class C. FIG. 8 shows that only the subband b is allocatable to a mobile terminal #1 and a mobile terminal #3 because of being of the class A. FIG. 8 shows that the subbands b and c are allocatable to a mobile terminal #2 and a mobile terminal #4, respectively, because the former is of the class C and the latter is of the class B. The above is an explanation of FIG. 8.

Returning to FIG. 6, the uplink subband determination function 320 judges whether the interference is large or small by predicting the interference for each uplink subband, and notifies the determination result to the uplink band limitation decision function 321. Regarding the method of interference prediction, the radio access measurement function 241 measures the received power of the pilot signal transmitted by the mobile terminal belonging to another base station, and judges that the subband is large interference whose received power is large and judgeds the subband is small interference whose received power is small. Alternatively, as an other method, it can receive a notification of information on largeness or smallness of the transmit power of the mobile terminal belonging to each subband from a single or a plurality other base stations through the network, and judge that the subband such that the base stations notifying large transmit powers exist more than or equal to the threshold has large interference and other subbands have small interference. Further, alternatively, it is also possible to judge that the subband such that the base stations notifying large transmit powers are more in number has larger interference. Still further alternatively, largeness or smallness of the interference for each subband is notified directly from the network through the backhaul access function 230.

The uplink band limitation decision function 321 decides the limitation for each subband based on the interference largeness/smallness determination result for each subband and the notification from the cell environment judgment function 300, and notifies the decided limitation that is associated with the subband to the uplink mobile terminal limitation decision function 323. That is, if the notification from the cell environment judgment function 300 is the avoidance type, it selects a stricter limitation for the subband that is judged to have larger interference, selects a looser limitation for the subband that is judged to have smaller interference, and notifies the selected limitation to the uplink mobile terminal limitation decision function 323. If the notification from the cell environment judgment function 300 is the collision type, it selects a looser limitation for the subband that is judged to have larger interference, selects a stricter limitation for the subband that is judged to have smaller interference, and notifies the selected limitation to the uplink mobile terminal limitation decision function 323.

Here, stricter limitation means that a condition imposed on the mobile terminal to which the resource is allocatable is strict. This indicates that the subband whose limitation is strict can be assigned only to the mobile terminal whose necessary power for communication is lower, and the mobile terminal whose necessary power for communication is higher cannot be assigned to the subband whose limitation is stricter. Incidentally, the subband whose limitation is the strictest means the subband that cannot be assigned to any mobile terminals. The uplink mobile terminal classification function 322 estimates the power requirement to perform communication for each mobile terminal, decides a larger uplink mobile terminal class as the necessary power becomes larger, and notifies it to the uplink mobile terminal limitation decision function 323.

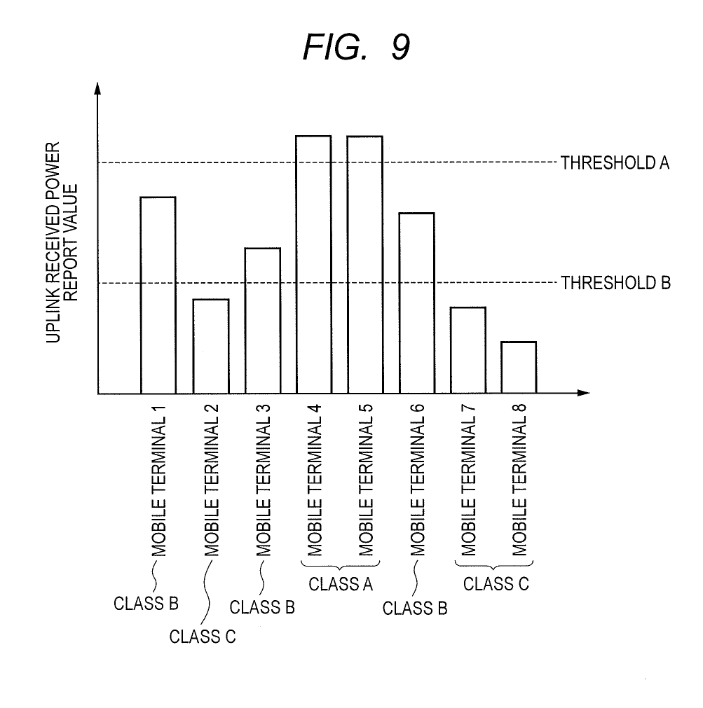

FIG. 9 is a diagram showing one example of an outline of uplink mobile terminal class determination in the uplink mobile terminal classification function 322. In an uplink mobile terminal class determination processing, the uplink transmit power reported from each mobile terminal is compared with the threshold and is classified as follows: mobile terminals each having reported the uplink transmit power higher than or equal to the threshold A are of the class A; mobile terminals each having reported the uplink transmit power lower than the threshold A and not lower than the threshold B are of the class B; and mobile terminals other than those are of the class C. In the case of the example of FIG. 9, since the mobile terminals belonging to the class A have the highest transmit power, the class A is the highest class, and after this, the class B and the class C are lower classes in this order.

Moreover, although the example of FIG. 9 shows an example in which eight mobile terminals are classified into three classes according to the uplink transmit power, the number of mobile terminals and the number of classes for the classification are not limited to these values. Moreover, regarding the uplink transmit power reported from each mobile terminal, the report value may be used directly or may be used after the values are averaged over a fixed time. Moreover, the uplink transmit power reported from each mobile terminal may be not the transmit power as it is, but may be, for example, a transmit power margin (Power Headroom) which is a difference of the transmit power value decided by a procedure of power control and the maximum transmit power value of the mobile terminal.

Moreover, the thresholds used for the classification may be varied according to the result of the classification. For example, by decreasing the threshold A when the number of mobile terminals belonging to the class A as the result of the classification is smaller than the assumption, and conversely by increasing the threshold A when the number of mobile terminals belonging to the class A is more than the assumption, it is possible to restrict the number of mobile terminals for each class in an assumed range. Alternatively, by decreasing the thresholds in the case where the mobile terminals are less in number compared to the surrounding cells, and by increasing the respective thresholds in the case where the mobile terminals are many in number compared to the surrounding cells, it is also possible to achieve load distribution among cells.

Moreover, the downlink mobile terminal class by the downlink mobile terminal classification function 312 and the uplink mobile terminal class by the uplink mobile terminal classification function 322 do not need to be the same. That is, even if the number of classes into which the mobile terminals are classified is the same between the uplink case and the downlink case, they may belong to different classes in the uplink case and in the downlink case as in the example of the mobile terminal 7 of FIG. 7 and FIG. 8. Furthermore, in the first place, the number of classes into which the mobile terminals are classified may be different between the uplink case and the downlink case, like a case where the uplink mobile terminals are classified into three classes and the downlink mobile terminals are classified into two classes.

Returning to FIG. 6, the uplink mobile terminal limitation decision function 323 judges that the subband whose limitation is strict can be assigned only to the mobile terminal of the low class and only the subband whose limitation is loose can be assigned to the mobile terminal of the high class based on the limitation for each subband notified from the uplink band limitation decision function 321 and the class of each mobile terminal notified from the uplink mobile terminal classification function 322, judges the possibility of assignment or the assignment priority for each subband of the each mobile terminal, and notifies the determination result to the radio resource assignment function 221. The information that is notified is the same as the downlink case of FIG. 8.

Based on the notified possibility of assignment information for each mobile terminal and each subband, the radio resource assignment part 221 assigns the radio resource to the mobile terminal so that the radio resource may not be assigned to a combination of the mobile terminal whose requirement value of the transmit power is high and the subband whose limitation is strict that comes to non-allocatability.

Incidentally, although both of the downlink and uplink configurations were described as the inter-cell interference coordination function in the above, the both of the downlink and uplink inter-cell interference coordination functions may be used, or only one of the downlink and uplink inter-cell interference coordination functions may be used.

The radio resource assignment function 221 performs scheduling based on pieces of information on the allocatable subband for each mobile terminal that are notified from the downlink mobile terminal limitation decision function 313 and the uplink mobile terminal limitation decision function 323. The above is an explanation of FIG. 6.

As explained above, the femtocell base station 111 having the inter-cell interference coordination function of FIG. 6 specifies the cell environment showing a relationship with the other macrocell base station according to a situation of the propagation path, judges the interference from the macrocell base station for each subband, and decides the transmit power that is allocatable and the mobile terminal to which the transmit power is allocatable for the each subband. The femtocell base station notifies a transmit power value and information on the subband that is assigned to the mobile terminal, and performs the scheduling of the radio resource assignment.

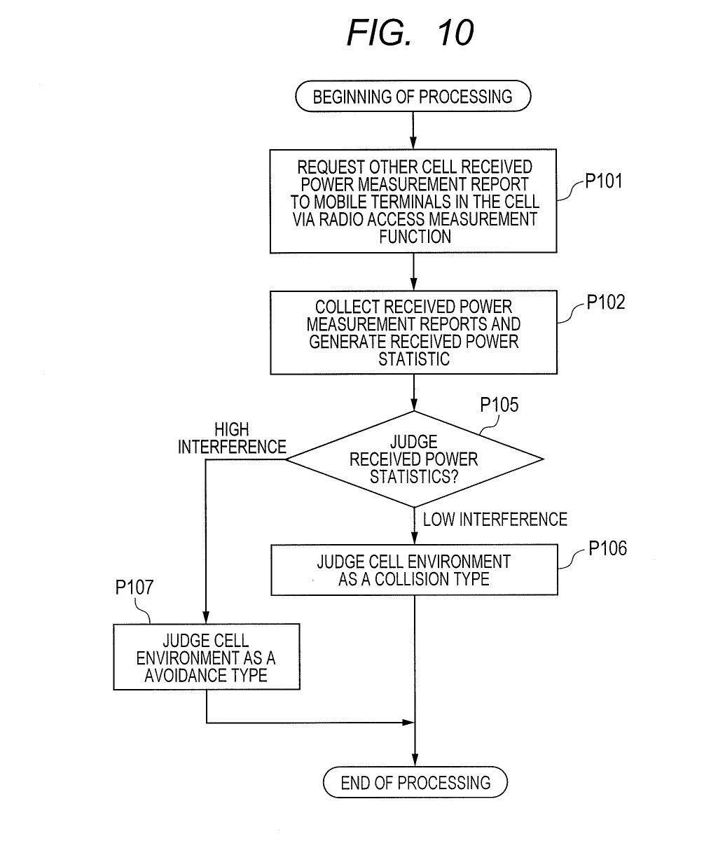

Below, FIG. 10 through FIG. 14 give a detailed explanation of the cell environment judgment function 300.

FIG. 10 is a diagram showing one example of a flow of a processing of cell environment determination in the cell environment judgment function 300. In the cell environment determination processing of the example of FIG. 10, first, in a processing P101, the cell environment judgment function 300 requests a report of a received power value measurement result of the other cell to the mobile terminal within the cell through the radio access measurement function 241. Subsequently, in a processing P102, the cell environment judgment function 300 collects the reports of the received power value measurement results and generates the received power statistic. Here, the received power statistics is a typical value of an average, a maximum, anyone of values that divide a set of data into n equal parts (hereinafter referred to as “percentiles”), or the like of received power values.

Subsequently, in a processing P105, the cell environment judgment function 300 judges whether the power is high or low based on the received power statistic. In the case where a representative value, such as the average value, the maximum value, any one of other percentiles, etc., is used as the received power statistic, the cell environment judgment function 300 compares the representative value and the threshold to judge whether the interference is high or low: if the representative value is larger than the threshold, it will judge that the interference is high interference; and if the representative value is smaller than the threshold, it will judge that the interference is low interference. In the processing P105, if the cell environment judgment function 300 judges that the interference is low interference, it will judge that the cell environment is the collision type in a processing P106, and outputs a purport that “the cell environment is the collision type” to the downlink band limitation decision function 311 and the uplink band limitation decision function 321. On the other hand, in the processing P105, if the cell environment judgment function 300 judges that the interference is high interference, it will judge that the cell environment is the avoidance type in a processing P107, and outputs a purport that “the cell environment is the avoidance type” to the downlink band limitation decision function 311 and the uplink band limitation decision function 321.

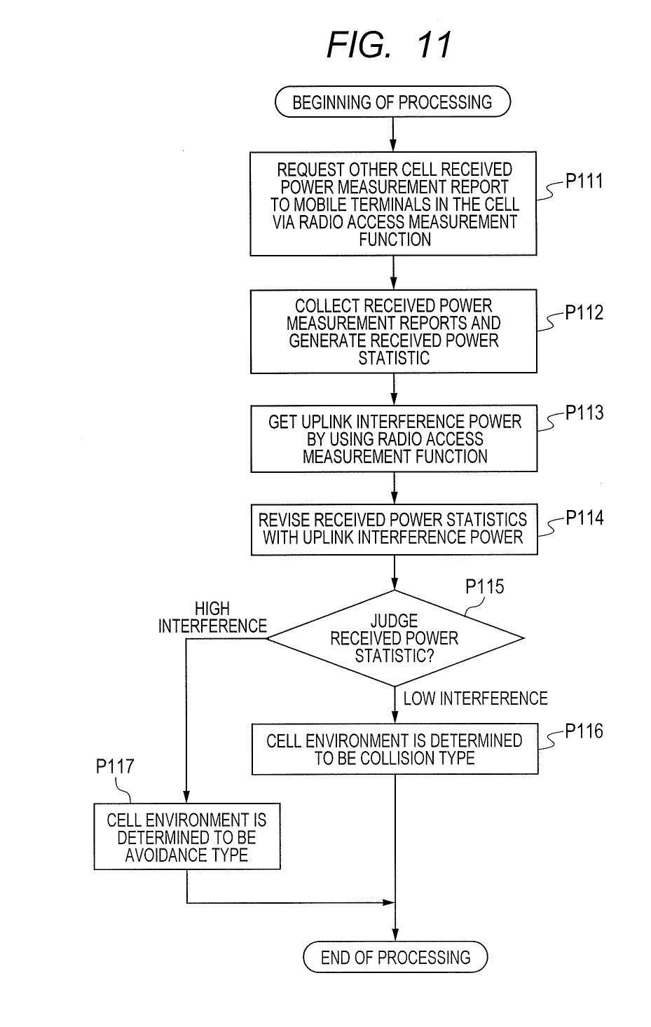

Incidentally, the received power statistic may be apiece of information on a distribution of a report frequency of the received powers more than or equal to a threshold, etc. In the case where the information on the distribution of the report frequency of the received power more than or equal to the threshold is used as the received power statistic, in the processing P105, the cell environment judgment function 300 judges that when the frequency is higher than a frequency threshold, the interference is high interference, and when the frequency is lower than that, the interference is low interference. The flow proceeds to the processing P106 or the processing P107 according to the determination result. FIG. 11 is a diagram showing one example of a flow of the cell environment determination in the cell environment judgment function 300 that is different from FIG. 10.

A main difference from FIG. 10 is that a processing P113 and a processing P114 are added after the processing P102, and the received power statistic is revised using an uplink interference power. Below, a detailed explanation will be given.

In the processing P113, the cell environment judgment function 300 gets the uplink interference power using the radio access measurement function 241. Incidentally, in order to acquire the uplink interference power, the interference power may be measured in the processing P113 or the uplink interference power having been measured at another opportunity may be used. Subsequently, in the processing P114, the cell environment judgment function 300 revises the received power statistic generated in the processing P112 using the uplink interference power gotten in the processing P113. The correction means, for example, in the case where a representative value, such as the average value, the maximum value, and any one of other percentiles, is used as the received power value, subtracting a value having a positive correlation with the uplink interference power value from the representative value, or dividing the representative value by the uplink interference power value. The processings after the processing P115 are the same as those of FIG. 10.

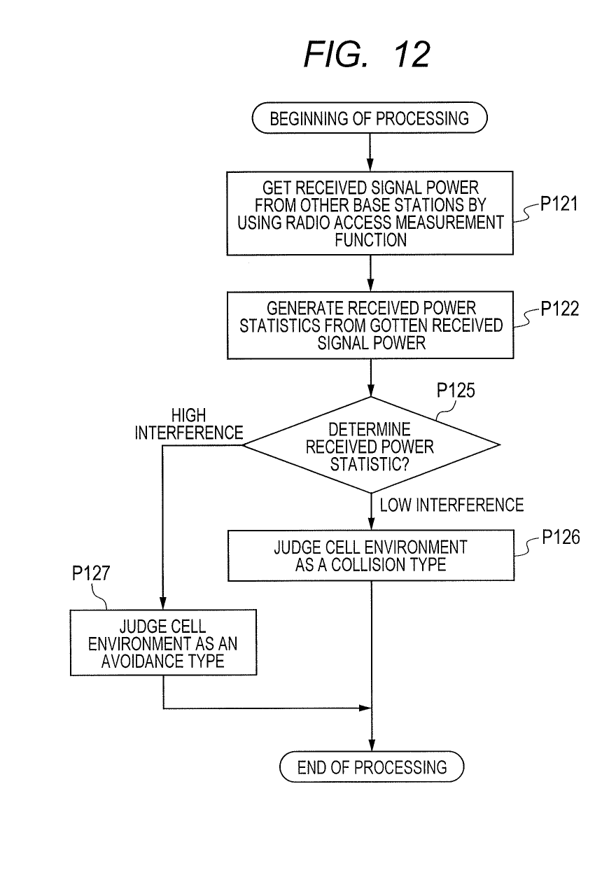

FIG. 12 is a diagram showing a flow of the cell environment determination in the cell environment judgment function 300 that is an other example of FIG. 10. A main difference from FIG. 10 is that the cell environment judgment function 300 performs a processing P121 and a processing P122 instead of the processing P101 and the processing P102. Below, a detailed explanation will be given.

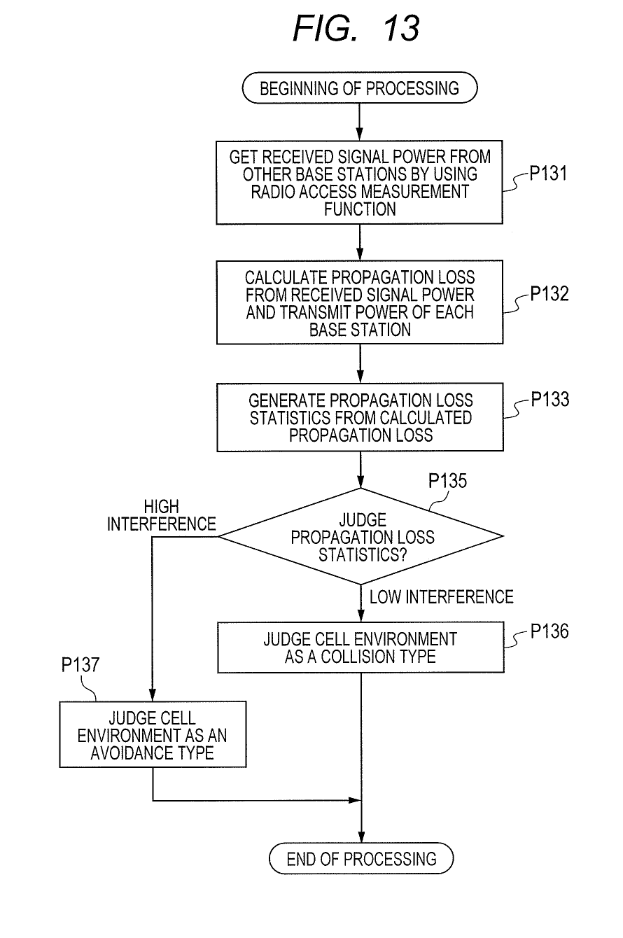

First, in the processing P121, the radio access measurement function 241 gets the received power of the signal from one or plural other base stations. Incidentally, in order to acquire the received power of the signal from an other base station, the received power may be measured in the processing P121, or the received power measured in another opportunity may be used. Subsequently, in a processing P122, the cell environment judgment function 300 collects the received power values and generates the received power statistic. Here, the received power statistic is a representative value, such as the average value, the maximum value, and any one of other percentiles of the received power values. Alternatively, for example, a piece of information on a distribution of the received power value more than or equal to the threshold, etc. may be used. A processings thereafter is the same as the processing P105 or the processing P107 of FIG. 10. FIG. 13 is a diagram showing one example of a flow of the processing of the cell environment determination in the cell environment judgment function 300 that is different from FIG. 10. A main difference from FIG. 10 is that in order to judge the cell environment, determination of interference is performed using both the received power of the signal transmitted from an other base station and the transmit power of the base station that transmits the signal, which corresponds to a processing P131 to a processing P134. Below, a detailed explanation will be given. In the processing P131, first, the radio access measurement function 241 gets the received powers of the signals from one or plural other base stations. Incidentally, in order to acquire the received power of the signal from the other base station, the received power may be measured in the processing P131 or the received power having been measured at another opportunity may be used. Subsequently, in a processing P132, the cell environment judgment function 300 gets a transmit power of the signal of the base station that is a transmission source of that signal whose received power was measured in the processing P131, and calculates propagation loss between the other base station and the local station from a ratio of the transmit power and the received power measured in the processing P131. Subsequently, in a processing P133, the cell environment judgment function 300 collects the propagation losses, and generates a propagation attenuation statistic. Here, the propagation attenuation statistic is a representative value of, for example, the average value, the maximum value, or any one of other percentiles, etc. of the propagation losses. Moreover, for example, a piece of information on a distribution of frequencies of the propagation losses more than or equal to the threshold, etc. may be used.

Subsequently, in a processing P135, the cell environment judgment function 300 judges whether the interference is high or low based on the propagation attenuation statistic. In the case where the representative value, such as the average value, the maximum value, and any one of other percentiles, is used as the propagation attenuation statistic, the determination as to whether the interference is high or low is performed by a comparison of the representative value and the threshold: if the representative value is larger than or equal to the threshold, the interference will be judged low and the flow will proceed to the processing P106; and if the representative value is smaller than the threshold, the interference will be judged high and the flow will proceed to the processing P107. Incidentally, for example, in the case where information of a distribution such as frequencies of propagation losses more than the threshold etc. is used as the propagation attenuation statistic, in the processing P135, if the frequency is higher than the frequency threshold regarding the determination of high/low interference, the cell environment judgment function 300 will judge that the interference is low interference, and will make the flow proceed to the processing P106, and if the frequency is lower than that, it will judge that the interference is high interference, and will make the flow proceed to the processing P107. The above is an explanation of FIG. 13.

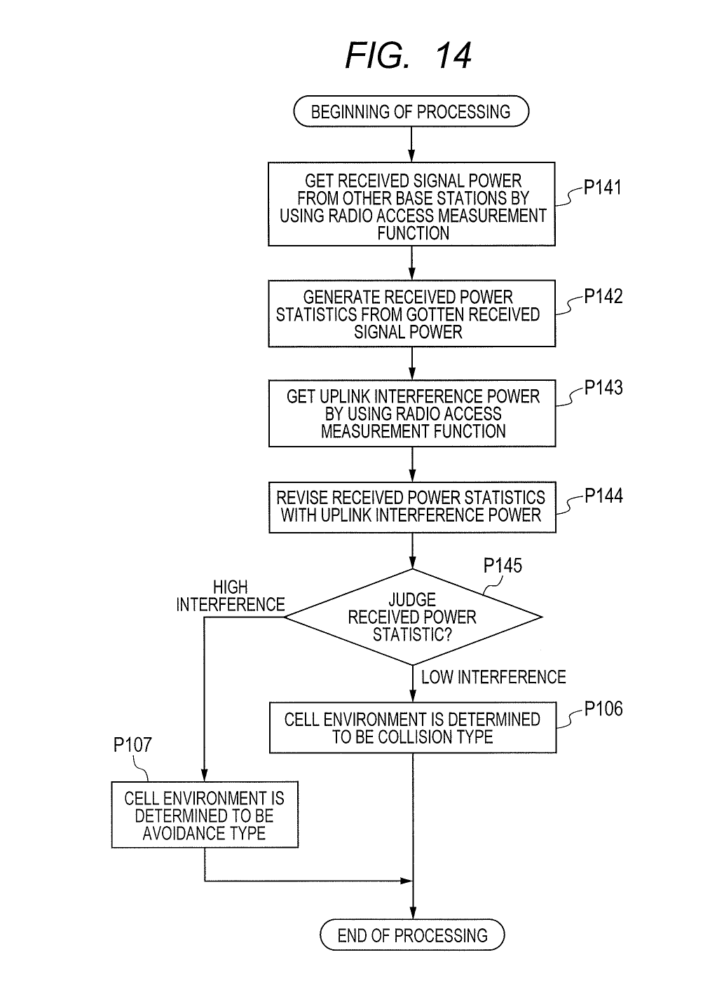

FIG. 14 is a diagram showing one example of the flow of the processing of the cell environment determination in the cell environment judgment function 300 that is different from FIG. 10. What are different from FIG. 10 are that it gets a signal received power from an other base station that corresponds to the processing P121 and the processing P122 of FIG. 12 and generates the received power statistic and that it revises the generated received power statistic that corresponds to the processing P113 and the processing P114 of FIG. 11 using the uplink interference power.

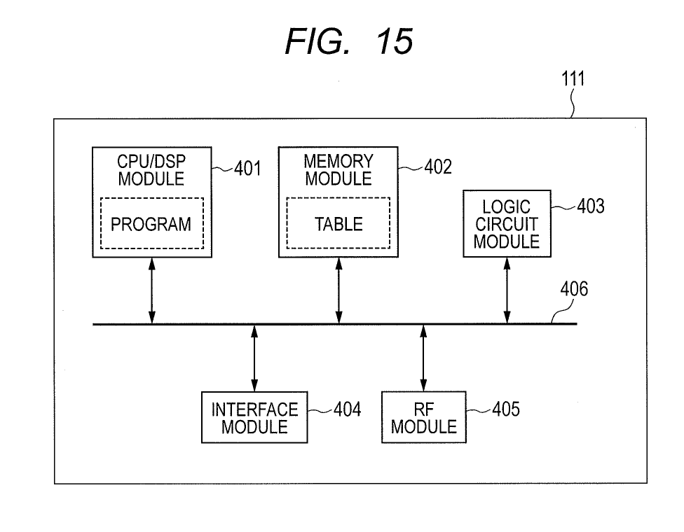

FIG. 15 is a diagram showing one example of a configuration of the base station apparatus constructed with DSPs and/or CPUs as main constituents. The base station shown by FIG. 15 has a CPU/DSP module 401, memory module 402, a logic circuit module 403, an interface module 404, and an RF function 405, each of which is connected through a bus 406.

Each function in the configuration diagram of FIG. 2 is made to operate using either or both of a program in the CPU/DSP module 401 and an arithmetic circuit in the logic circuit module 403, and, if necessary, using the memory module 402. Pieces of information that each function in the configuration diagram of FIG. 2 needs, for example, a measurement result at the mobile terminal received from the mobile terminal, the thresholds used for the class classification of FIG. 7 and FIG. 8, the thresholds of the received power statistic used for determining the cell environment in the processing P105 of FIG. 10, and a table of FIG. 8 are retained in the memory module 402.

The network interface module 404 outputs and inputs a control signal, the transmitting signal before a signal processing, and the received signal after the signal processing. For the transmitting signal, the RF function 405 converts it into a signal in a radio frequency and transmits it through an antenna, and for the received signal, it converts the signal received through the antenna into a signal in a baseband.

Incidentally, in FIG. 15, each function and each bus do not necessarily need to be a single. For example, there may be multiple CPU/DSP modules 401, and there may be multiple buses 406. Moreover, in the case where there are multiple busses 406, all the busses do not necessarily need to be connected with all the modules, but, for example, there may be a bus for connecting only the memory module 402 and the logic circuit module 403 other than buses that connect with all the functions.

Moreover, for example, if the CPU/DSP module 401 is capable of performing each of a signal processing calculation and a signal processing control in all functions, the logical operation function 403 does not need to be included. Conversely, for example, if the logical operation function 403 is capable of performing each of the signal processing calculation and the signal processing control in all the functions, the CPU/DSP module 401 does not need to be included.

Incidentally, a configuration as shown in FIG. 2 may be implemented by each function of FIG. 2 being retained in the memory module 402 as a program and by the CPU/DSP module 401 reading and performing the program. Although the memory is not illustrated in FIG. 2, the radio base stations ill may be equipped with each function a database capable of being read and written, and the database may retain a measurement result at the mobile terminal received from the mobile terminal, the thresholds used for the classification of FIG. 7 and FIG. 8, the threshold of the received power statistic used for determining the cell environment in the processing P105 of FIG. 10, and a table of FIG. 8.

The embodiment explained above may be applied to a case where each of the macrocell base stations performs the resource assignment using a different transmit power for each subband, such as fractional frequency reuse (FFR).

What is claimed is:

1. A base station apparatus for performing multi-carrier radio communication having a plurality of sub-carriers with a plurality of mobile terminal apparatuses, comprising:
a cell environment determination processing part for estimating interference values from surrounding cells;
a scheduler for performing resource assignment to the mobile terminals on a basis of subband-by-subband consisting of one or a plurality of sub-carriers; and
an inter-cell interference coordination processing part for deciding a transmit power limitation that restricts an allocatable resource for the each subband based on said estimated interference values.

2. The base station apparatus according to claim 1,
wherein when a result of cell interference value estimation by the cell environment determination processing part is presumed to be strong interference,
the inter-cell interference coordination processing part makes a transmit power limitation of the subband that was presumed to have a small interference value strict, and makes the transmit power limitation of the subband that was presumed to have a large interference value loose.

3. The base station apparatus according to claim 2,
wherein the cell environment determination processing part presumes that the interference is strong interference when a received power is large,
based on the received power that the mobile terminal measured on a signal transmitted by a base station apparatus different from said base station apparatus.

4. The base station apparatus according to claim 2,
wherein the cell environment determination processing part presumes that the interference is strong interference when a ratio of a received power and an uplink interference power is large,
based on the received power that the mobile terminal measured on a signal transmitted by base station apparatus different from said base station apparatus and the uplink interference power that said base station apparatus measured.

5. The base station apparatus according to claim 2,
wherein the cell environment determination processing part presumes that the interference is strong interference when a received power is large,
based on the received power that said base station measured on a signal transmitted by a base station apparatus different from said base station apparatus.

6. The base station apparatus according to claim 2,
wherein the cell environment determination processing part compares a received power that said base station measured on a signal transmitted by base station apparatus different from said base station apparatus and a transmit power of the different base station apparatus and, if a ratio of the transmit power and the received power is large, presumes that the interference is strong interference.

7. The base station apparatus according to claim 2,
wherein the cell environment determination processing part presumes that a signal transmitted by a base station apparatus different from the base station apparatus is strong interference based on a received power that the base station measured and an uplink interference power that the base station apparatus measured when a ratio of the received power and the interference power is small.

8. A method for assigning a radio resource in order to perform multi-carrier radio communication in which a base station apparatus has a plurality of mobile terminal apparatuses and a plurality of sub-carriers, the method comprising the steps of:
estimating an interference quantity from surrounding cells;
deciding a transmit power limitation that limits an allocatable resource for each subband consisting of one or a plurality of sub-carriers based on the interference quantity estimation result, and
performing resource assignment on mobile terminals on a subband-by-subband basis based on the decided transmit power limitation.

9. The method for assigning a radio resource according to claim 8,
wherein:
when a result of cell interference quantity estimation is presumed to be strong interference by the step of estimating an interference quantity,
the step of deciding a transmit power limitation makes strict a transmit power limitation of the subband that was presumed to have a small interference quantity, and makes loose the transmit power limitation of the subband that was presumed to have a large interference quantity.

10. The method for assigning a radio resource according to claim 9,
wherein:
the step of the step of estimating an interference quantity presumes that the interference is strong interference when a received power is large based on the received power that the mobile terminal measured on a signal transmitted by a base station apparatus different from the base station apparatus.
